(19) United States
(12) Patent Application Publication
(10) Pub. No.: US 2026/0314858 A1
(43) Pub. Date: Oct. 15, 2026

(54) EQUIPMENT STORAGE DEVICE AND ASSOCIATED METHODS

(71) Applicant: Elevated State of Design LLC, Denver, CO (US)

(72) Inventor: Evan JONES, Denver, CO (US)

(73) Assignee: Elevated State of Design LLC, Denver, CO (US)

(21) Appl. No.: 19/644,143

(22) Filed: Apr. 10, 2026

Related U.S. Application Data
(60) Provisional application No. 63/786,663, filed on Apr. 10, 2025.

(51) Int. Cl. A47G 25/06

(52) U.S. Cl. CPC A47G 25/0664

(57) ABSTRACT

A storage device system includes an attachment portion, a central rod supported by the attachment portion, a branch connector supported on the central rod, wherein the branch connector includes a plurality of openings, and a plurality of branch rods supported in the openings. Each opening is sized and shaped to removably accommodate a branch rod therein. Each branch rod is sized and shaped to fit into an opening via friction or snap fit. The storage device system further includes a top portion supported at a top end of the central rod. The top portion may include a flat surface, a protrusion, an opening, a hook, and/or a slot thereon for accommodating attachment of another component thereto. The central rod may include a channel for accommodating electrical wires therethrough, and the top portion may include an electrical connection mechanism electrically connected with the one or more electrical wires.

### BACKGROUND

Cold weather sports require protective gear. For instance, skiers and snowboarders must protect themselves from cold conditions with gloves, hats, helmets, cowls, and other small equipment. However, when they enter a warm building such a ski lodge, to take a break or to enjoy a meal, such protective gear become unnecessary while they are in the building. The protective gear often get piled up on a table or a chair, making such furniture unavailable for use.

For instance, a restaurant at a ski lodge frequently accommodates a rush of diners at lunch time, coming into the building from the cold weather. When the diners take up valuable table space with their discarded cold weather gear, this condition reduces the number of diners that may be accommodated within the restaurant, leading to lost business as well as frustrated customers.

There are other situations in which a group of people with a variety of equipment (e.g., hats, gloves, scarves, goggles, helmets) need to temporarily remove the equipment when meeting, eating, etc., such as construction sites, laboratories, and factories.

Thus, there is a need for an improved storage solution for temporary storage of a variety of small equipment in a crowded setting.

### BRIEF SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

In an embodiment, a storage device suitable for affixing to a surface is disclosed. The storage device includes a central rod, and an attachment device configured for affixing the central rod to the surface. The storage device further includes a plurality of branch rods and a branch connector, the branch connector being configured to attach to the central rod and configured to support the plurality of branch rods therewith.

In embodiments, the branch connector is configured for supporting the plurality of branch rods at an acute angle with respect to the central rod.

In embodiments, the branch connector is configured for supporting the plurality of branch rods such that each one of the plurality of branch rods protrudes at a different location with respect to a circumference of the central rod.

In embodiments, the branch connector is further configured to be removably attached to the central rod.

In embodiments, the storage device includes a second central rod, and the branch connector is further configured to attach to the second central rod such that the second central rod is aligned along a longitudinal axis of the first mentioned central rod.

In certain embodiments, the storage device includes a second branch connector, wherein the first mentioned branch connector is attached to a first end of the second central rod, and wherein the second branch connector is attached to a second, opposing end of the second central rod.

In certain embodiments, the storage device includes a topper (also referred to as a top portion), wherein the first mentioned branch connector is attached to a first end of the second central rod, and the topper is attached to a second, opposing end of the second central rod. In embodiments, the topper includes at least one of a slot, a hole, a hook, a flat surface, a protrusion, and a display screen.

In embodiments, wherein the surface includes a first side and a second side, opposite the first side, wherein the storage device is configured for being affixed to the first side of the surface, wherein the attachment device includes a mounting component configured for attachment to the second side of the surface.

In embodiments, a storage device system includes an attachment portion, a central rod supported by the attachment portion at a bottom end of the central rod, a branch connector supported on the central rod, wherein the branch connector includes a plurality of openings, and a plurality of branch rods supported in the plurality of openings. Each one of the plurality of openings is sized and shaped to removably accommodate one of the plurality of branch rods therein.

In certain embodiments, each one of the plurality of branch rods is sized and shaped to fit into one of the plurality of openings via one of a friction fit and a snap fit. In certain embodiments, the storage device system further includes a top portion supported at a top end of the central rod. In embodiments, the top portion includes one or more of a flat surface, a protrusion, an opening, a hook, and a slot thereon for accommodating attachment of another component thereto. In embodiments, the central rod includes a channel therethrough for accommodating one or more electrical wires therethrough, and the top portion includes an electrical connection mechanism electrically connected with the one or more electrical wires. In embodiments, the storage device system further includes an electronic display connected with the electrical connection mechanism and supported on the top portion.

In certain embodiments, the attachment portion includes a first attachment component and a second attachment component, the first attachment component is attachable to a bottom surface of a flat object, and the second attachment component matingly attaches with the first attachment component from a top surface of the flat object such that the central rod is insertable into the second attachment component from the top surface of the flat object. In embodiments, the plurality of branch rods includes a first set of branch rods of a first length and a second set of branch rods of a second length.

In certain embodiments, the storage device system further includes a second central rod, wherein the branch connector includes at least two central openings for accommodating the central rod the second central rod therein. In embodiments, the branch connector includes a central opening for accommodating the central rod therethrough. In embodiments, the storage device further includes one or more attachment mechanisms for securing the branch connector onto the central rod upon positioning of the central rod through the central opening of the branch connector. In embodiments, the one or more attachment mechanisms comprises a pin, a screw, and a nail.

In embodiments, a method includes providing a storage system, the storage system including an attachment portion, a central rod, a branch connector, and a plurality of branch rods, wherein the branch connector includes a plurality of openings, each one of the plurality of openings being sized and shaped to accommodate one of the plurality of branch rods therein. The method further includes attaching the attachment portion to a surface of an object, matingly inserting the central rod into the attachment portion, affixing the branch connector on the central rod, and inserting one or more branch rods into the plurality of openings of the branch connector.

In embodiments, the method further includes disassembling the plurality of branch rods, the branch connector, the central rod, and the attachment portion, and consolidating the plurality of branch rods, the branch connector, the central rod, and the attachment portion into a compact package.

In embodiments, the method further includes reconfiguring the storage system by adjusting placement of the one or more branch rods with respect to the branch connector.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a,’ ‘an,’ and ‘the’ include plural referents unless the context clearly dictates otherwise.

### BRIEF DESCRIPTION OF THE DRAWINGS

The disclosure may be better understood by reference to the following description taken in conjunction with the accompanying drawings in which:

FIG. 1 illustrates a storage device, in accordance with embodiments.

FIG. 2 shows a partially exploded, perspective view of the storage device of FIG. 1, in accordance with embodiments.

FIG. 3 shows an example configuration of the storage device of FIG. 1 as affixed to a table, in accordance with embodiments.

FIG. 4 shows an example configuration of a top portion of a modified storage device, in accordance with embodiments.

FIG. 5 shows another example configuration of a top portion of an alternative storage device, in accordance with embodiments.

For simplicity and clarity of illustration, the drawing figures illustrate the general manner of construction, and descriptions and details of well-known features and techniques may be omitted to avoid unnecessarily obscuring the embodiments detailed herein. Additionally, elements in the drawing figures are not necessarily drawn to scale. For example, the dimensions of some of the elements in the figures may be exaggerated relative to other elements to help improve understanding of the described embodiments. The same reference numerals in different figures denote the same elements.

The word “exemplary” is used herein to mean “serving as an example, instance, or illustration.” Any embodiment described herein as “exemplary” is not necessarily to be construed as preferred or advantageous over other embodiments. In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or apparatuses.

The following detailed description is therefore not to be taken in a limiting sense, and the scope of the present disclosure is defined by the appended claims and their equivalents.

### DESCRIPTION OF ILLUSTRATIVE EMBODIMENTS

Embodiments of a storage device described herein aim to solve the problems listed above by providing a compact, sturdy, and multiplexed system for accommodating a variety of items stored thereon. In embodiments, the storage device is configured to be attachable to a surface, such as a tabletop or a shelf. Further, additional functionality, such as the ability to accommodate signage thereon, may be provided in certain embodiments.

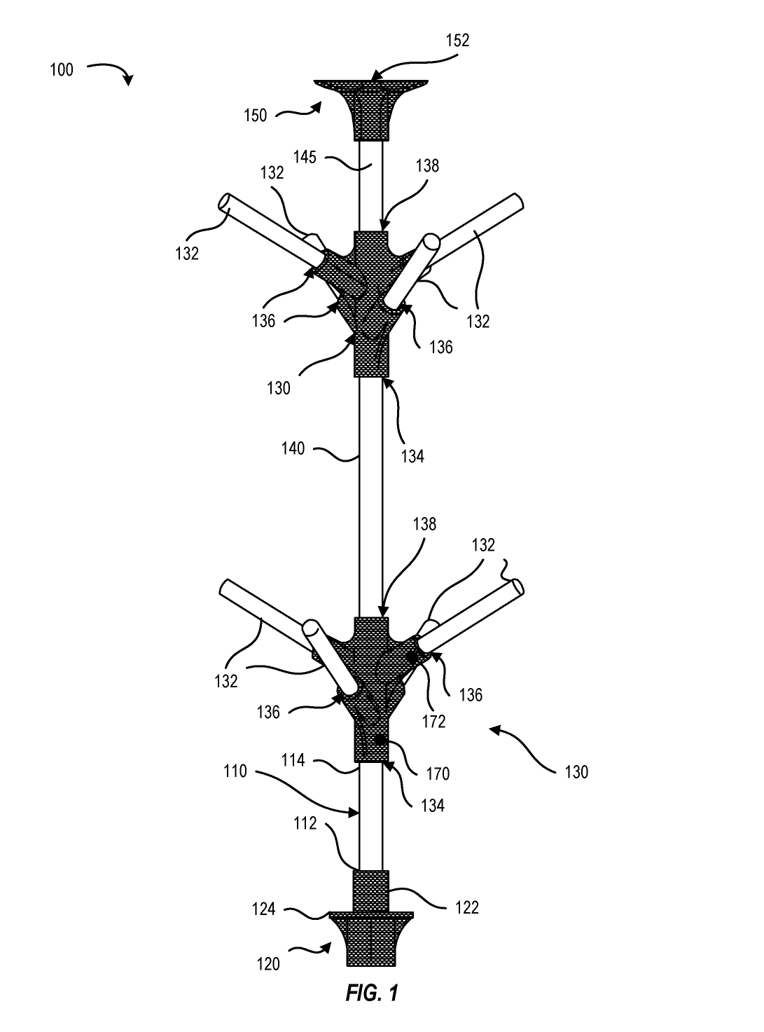

FIG. 1 shows a storage device, in accordance with an embodiment. The example storage device of FIG. 1 may be easily affixed to, for example, a table in a restaurant such as in a ski lodge. The storage device may be used for temporary storage of small equipment, such as gloves, hats, helmets, goggles, small packs, and other paraphernalia as commonly brought into a ski lodge establishment.

As shown in FIG. 1, a storage device 100 includes a central rod 110 with a first end 112 and a second end 114. Storage device 100 further includes an attachment device 120 configured for affixing the central rod to a surface, such as a table (not shown in FIG. 1). In an example, a hole may be cut into the table to accommodate a top portion of the attachment device therein such that the attachment device is insertable into the hole from the bottom of the table. The attachment device itself may be screwed, nailed, glued, or otherwise affixed to the bottom of the table. In an alternative embodiment, the attachment device may be configured to cooperate with a clamp (e.g., a vice grip or a table clamp as commonly used in a machine shop) to be attachable to a table or another surface without requiring the cutting of a hole.

The attachment device includes a sleeve 122 to accommodate central rod 110 therein by, for example, friction fit or screw fit. Optionally, a grommet 124 may be provided around sleeve 122 to serve as a spacer and/or cushion between the table and attachment device 120. Alternatively, grommet 124 may be provided within sleeve 122 to provide an interface for central rod 110 when first end 112 of the central rod is inserted into attachment device 120.

Continuing to refer to FIG. 1, storage device further includes a branch connector 130 for accommodating a plurality of branch rods 132 therewith. In an embodiment, when first end 112 of central rod 110 is affixed to attachment device 120, branch connector 130 includes a first center opening 134 attachable to second end 114 of the central rod. Branch connector 130 further includes one or more branch openings 136 for additionally accommodating one or more branch rods 132. When inserted into branch connector 130, branch rods 132 may be oriented to protrude at different angles and/or locations around a circumference of central rod 110. For instance, at least one of branch rods 132 may be supported by branch connector 130 at an acute angle with respect to central rod 110 to enable accessories such as a hat or a fanny pack to be securely hooked onto the branch rod.

In an embodiment, branch connector 130 further includes a second center opening 138 for accommodating a second central rod 140 therein. In certain embodiments, first and second center openings 134 and 138 are oriented coaxially, as shown in FIG. 1. In other embodiments, first and second center openings 134 and 138 may be offset from each other in axial and/or angular orientation.

In embodiments, the openings provided in branch connector 130 are of a first diameter, the first diameter being just slightly larger than a branch rod diameter such that the branch rod is accommodated within the opening of the branch connector snugly with a tight friction fit.

Alternatively, branch connector and/or branch rods are configured with screw arrangements such that each branch rod may be matingly screwed into the branch connector in a secure manner.

In embodiments, storage device 100 further includes a top component 150, also attachable to either end of first or second central rod or a third central rod 145. Top component 150 is configured, for example, to provide a flat surface upon which various objects, such as a hat, a helmet, a menu, etc., may be supported. In an embodiment, top component 150 includes a slot 152 for accommodating, for example, a placard, a menu, an advertisement card, and other objects securely thereon. For instance, a diner may order food items at a remote counter and receive a placard with an order number; subsequently, when the order is ready, the food items can be brought to the table displaying the placard with the correct order number. Alternatively, top component 150 may include an electronic user interface to enable direct-from-table ordering, advertising display, and other functionalities. In examples, top component 150 further includes one or more of a slot, a hole, a hook, a flat surface, and a protrusion for accommodating the attachment of a variety of accessories thereto.

Branch connector 130 is further configured to be removably attachable to first central rod 110 and/or second central rod 140. In embodiments, the various openings and diameters of at least attachment device 120, first central rod 110, branch connector 130, and branch rods 132 are configured such that storage device 100 can be repeatably assembled and disassembled or reconfigured. Alternatively, the various openings and diameters of the components of storage device 100 may be configured to cooperate such that, once first central rod 110, attachment device 120, branch connector 130, and branch rods 132 are assembled, the components are affixed with respect to each other and difficult to take apart. The affixing may be performed, for example, by screw-in arrangements, tight friction fit, or the addition of an epoxy at the junctions between components. For example, as shown in FIG. 1, an attachment mechanism 170 (e.g., a nail, a pin, or a screw) may be used to affix the central rod onto the branch rod connector. Similarly an attachment mechanism 172 may be used to affix the branch rod onto the branch rod connector. In this way, storage device 100 may be shipped in a compact, disassembled manner, then assembled and installed at a desired location. In an alternative embodiment, a single central rod may be provided to accommodate one or more branch connectors therewith that are affixed, for example, by pins or screws such that the location of the one or more branch connectors on the single central rod may be adjusted by sliding the branch connector along the single central rod to a desired position, and affixed in place using pins or screws. Other configurations may also be contemplated and are considered a part of the present disclosure.

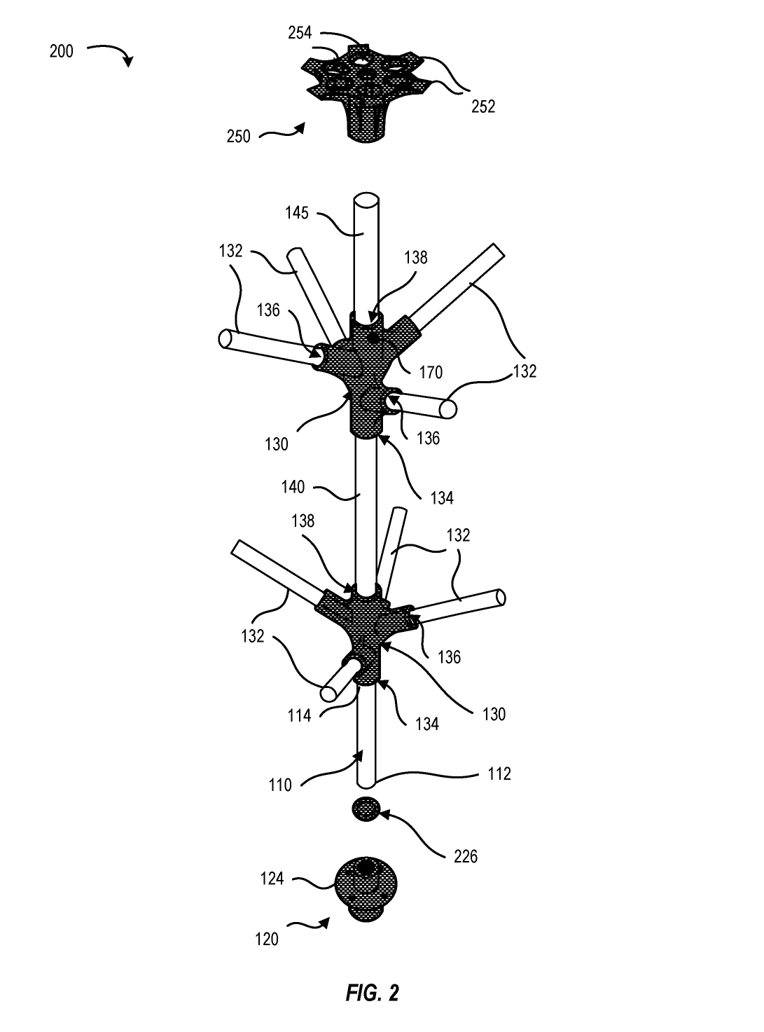

FIG. 2 shows a partially exploded view of a storage device, shown here to illustrate further details of the different components of the storage device, according with embodiments. As shown in FIG. 2, a storage device 200 shares many of the components of storage device 100 of FIG. 1. Storage device 200 further includes a spacer 226 to provide additional cushioning between first central rod 110 and attachment device 120 when first central rod is inserted into attachment device 120. Further, storage device 200 includes a top component 250, which in turn includes a plurality of protrusions 252 and openings 254. Protrusions 252 may be used, for example, for hanging coats, small bags, or other user equipment therefrom. Similarly, openings 254 may be used to support hooks, carabiners, and other components therethrough. In examples, top component 250 may be a basket from a ski pole, recycled for a new use. In fact, third central rod 145 and top component 250 may be formed from a portion of an old ski pole, in certain embodiments.

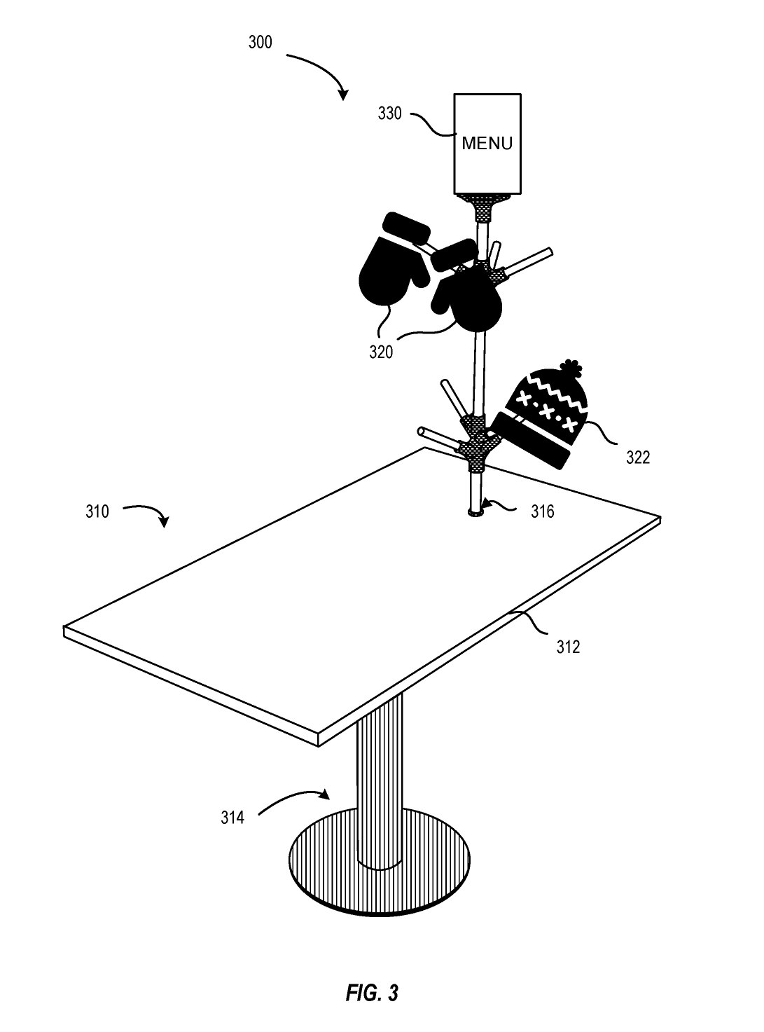

FIG. 3 shows an example storage device affixed to a table, in accordance with embodiments. As shown in FIG. 3, a storage device 300 is affixed to a table 310. In the illustrated example, table 310 includes a tabletop 312 supported on a table leg 314. An opening 316 is formed on tabletop 312 for accommodating at least a portion of an attachment device therethrough (e.g., attachment device 120 of FIGS. 1 and 2). It is noted that storage device 300 may be affixed to other surfaces with openings, such as a desk, a shelf, a cabinet, or other furniture.

The installation of storage device 300 using an arrangement such as an attachment device on tabletop 312 may be advantageous in certain use case scenarios, such as when storage device 300 is to be installed in public spaces, such as restaurants. In such situations, storage device 300 may be securely attached to tabletop 312 using a through-hole (e.g., opening 316) such that storage device 300 is not easily removable without the use of tools. In such cases, it may also be desirable to affix the branch rods and central rod(s) to their respective branch connectors and top component using, for example, epoxy, glue, screws, or other affixation mechanisms. In other situations, such as if an opening in the tabletop or attachment surface may not be desirable, a removable attachment mechanism, such as a clamp, may also be used in installing storage device 300 on a surface, such as tabletop 312. Other attachment modifications are contemplated and are considered a part of the present disclosure.

Continuing to refer to FIG. 3, various equipment, such as a pair of mittens 320 and a hat 322, may be supported on storage device 300. Further, if a slot is provided on the top component (e.g., slot 152 of FIG. 1), additional materials may be supported on the top component. For example, as shown in FIG. 3, a written menu 330 may be supported on a slot provided at the top component. In certain embodiments, written menu 330 may be replaced with an electronic display, such as a liquid crystal display, a light emitting diode display, a touchscreen display, and other devices for display of information, especially if storage device 300 is provided with electrical connections, as will be described below.

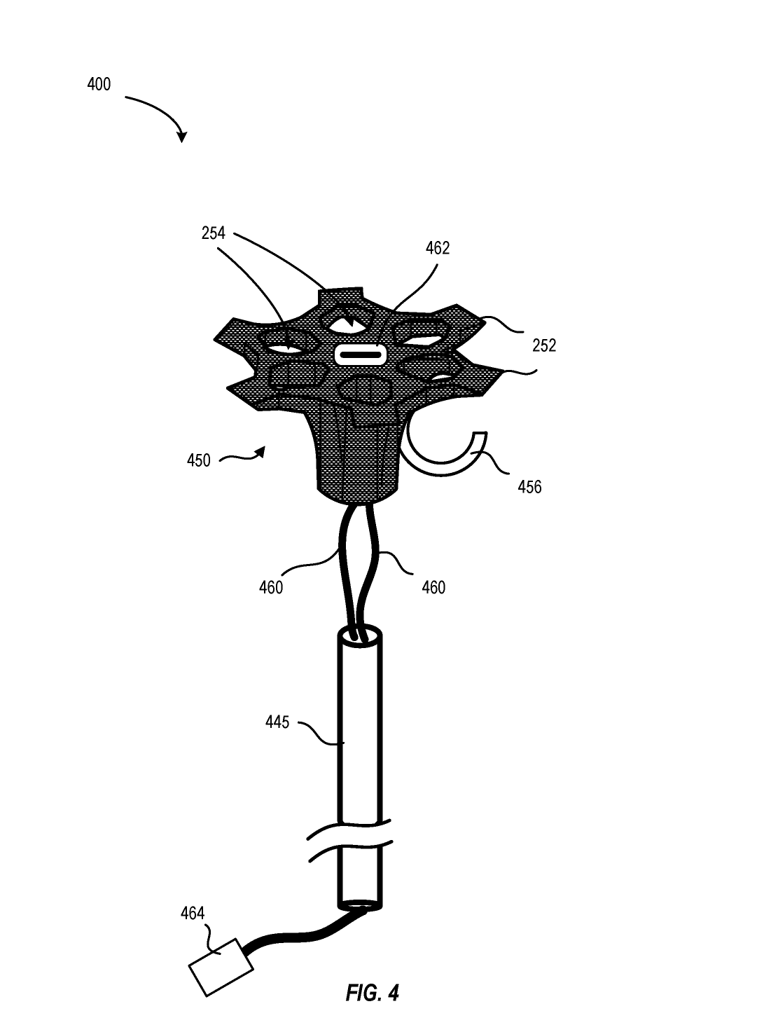

FIG. 4 shows an example configuration of a top portion of a modified storage device, in accordance with embodiments. As shown in FIG. 4, a portion 400 of a storage device (e.g., storage device 100, 200, or 300 of FIGS. 1, 2 or 3, respectively), includes a top portion 450 that provides electrical connectivity. Top portion 450 may still include previously discussed physical features, such as protrusions 252 and openings 254. Additional components, such as a hook 456, may also be provided.

Furthermore, top portion 450 is provided with electrical connectivity through a central rod 445 via electrical wires 460 fed through central rod 445 and connected with a port 462 and a connector 464. For instance, port 462 may accommodate a USB-A or USB-C or other electrical connection thereto. Connector 464 may be a standard electrical outlet plug, a USB-A or USB-C or other electrical connector. In this way, top portion 450 may supply electrical power therethrough for an electronic device conned thereto, such as a display or a user device.

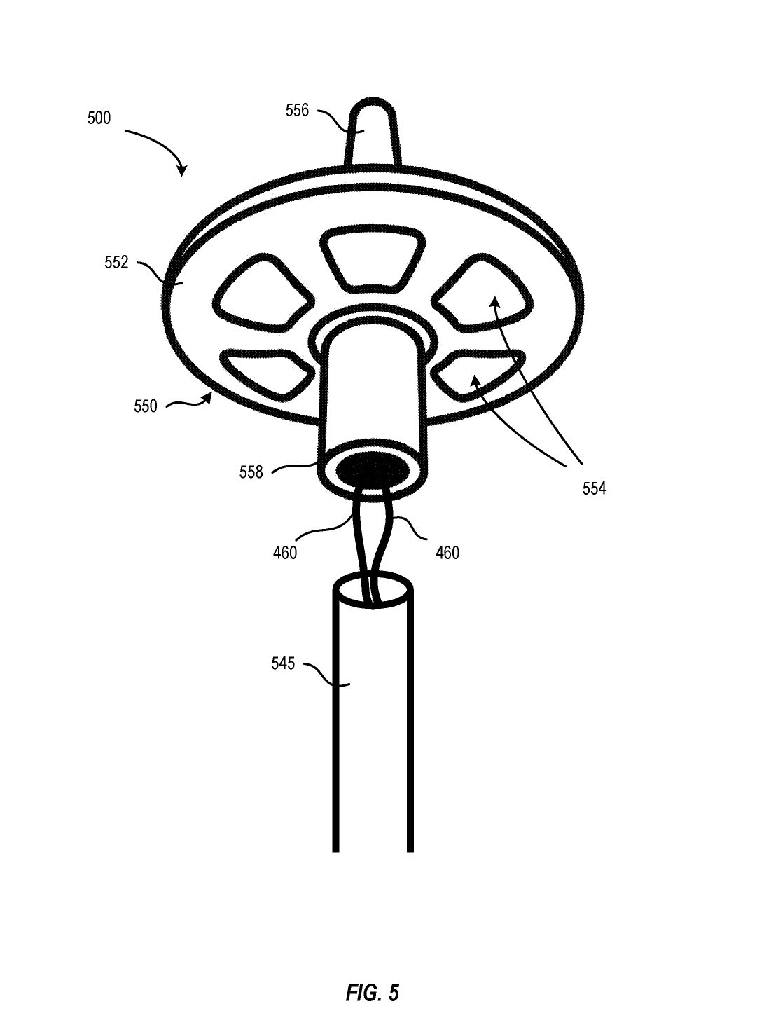

FIG. 5 shows another example configuration of a top portion of an alternative storage device, in accordance with embodiments. As shown in FIG. 5, a portion 500 of a storage device includes a top portion 550, which includes a basket ring 552, openings 554, a tip 556, and a tube portion 558 connectable with a . For instance, top portion 550 may be formed of a cut-off portion of a ski pole with a central rod 545 being of a diameter that may be accommodated into tube portion 558.

Additional modifications may be contemplated and are considered to be a part of the present disclosure. For example, rather than being attachable to a flat surface such as a table, a the central rod of the storage device described above may be configured to be supported by a stand such that the storage device may be moveably positioned on a table, floor, or another flat surface.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms, even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, by way of example only, the disclosure of a “protrusion” should be understood to encompass disclosure of the act of “protruding,” whether explicitly discussed or not, and, conversely, were there only disclosure of the act of “protruding,” such a disclosure should be understood to encompass disclosure of a “protrusion.” Such changes and alternative terms are to be understood to be explicitly included in the description.

What is claimed is:

1. A storage device system, comprising:
an attachment portion;
a central rod supported by the attachment portion at a bottom end of the central rod;
a branch connector supported on the central rod, wherein the branch connector includes a plurality of openings; and
a plurality of branch rods supported in the plurality of openings,
wherein each one of the plurality of openings is sized and shaped to removably accommodate one of the plurality of branch rods therein.

2. The storage device system of claim 1, wherein each one of the plurality of branch rods is sized and shaped to fit into one of the plurality of openings via one of a friction fit and a snap fit.

3. The storage device system of claim 1, further comprising a top portion supported at a top end of the central rod.

4. The storage device system of claim 3, wherein the top portion includes one or more of a flat surface, a protrusion, an opening, a hook, and a slot thereon for accommodating attachment of another component thereto.

5. The storage device system of claim 3, wherein:
the central rod includes a channel therethrough for accommodating one or more electrical wires therethrough, and
the top portion includes an electrical connection mechanism electrically connected with the one or more electrical wires.

6. The storage device system of claim 5, further comprising an electronic display connected with the electrical connection mechanism and supported on the top portion.

7. The storage device system of claim 1, wherein
the attachment portion includes a first attachment component and a second attachment component,
the first attachment component is attachable to a bottom surface of a flat object, and
the second attachment component matingly attaches with the first attachment component from a top surface of the flat object such that the central rod is insertable into the second attachment component from the top surface of the flat object.

8. The storage device of system claim 1, wherein the plurality of branch rods includes a first set of branch rods of a first length and a second set of branch rods of a second length.

9. The storage device system of claim 1, further comprising a second central rod, wherein the branch connector includes at least two central openings for accommodating the central rod the second central rod therein.

10. The storage device system of claim 1, wherein the branch connector includes a central opening for accommodating the central rod therethrough.

11. The storage device system of claim 10, further comprising one or more attachment mechanisms for securing the branch connector onto the central rod upon positioning of the central rod through the central opening of the branch connector.

12. The storage device system of claim 11, wherein the one or more attachment mechanisms comprises a pin, a screw, and a nail.

13. A method comprising:
providing a storage system, the storage system including an attachment portion, a central rod, a branch connector, and a plurality of branch rods, wherein the branch connector includes a plurality of openings, each one of the plurality of openings being sized and shaped to accommodate one of the plurality of branch rods therein;
attaching the attachment portion to a surface of an object;
matingly inserting the central rod into the attachment portion;
affixing the branch connector on the central rod; and
inserting one or more branch rods into the plurality of openings of the branch connector.

14. The method of claim 13, further comprising:
disassembling the plurality of branch rods, the branch connector, the central rod, and the attachment portion; and
consolidating the plurality of branch rods, the branch connector, the central rod, and the attachment portion into a compact package.

15. The method of claim 13, further comprising:
reconfiguring the storage system by adjusting placement of the one or more branch rods with respect to the branch connector.
